(19) United States
(12) Patent Application Publication
(10) Pub. No.: US 2022/0161369 A1
(43) Pub. Date: May 26, 2022

(54) APPARATUS FOR PROCESSING GLASS LAMINATE SUBSTRATE AND PROCESSING AND CUTTING METHODS USING THE SAME

(71) Applicant: CORNING INCORPORATED, CORNING, NY (US)

(72) Inventors: Joo Sok Kim, Yongin-si (KR); Woo Jin Lee, Cheonan (KR); Cheol Hee Park, Asan-si (KR); Michael William Price, Corning, NY (US); Dong Keun Shin, Hwasung-si (KR); Yuyin Tang, Kaohsiung City (TW)

(21) Appl. No.: 17/432,648

(22) PCT Filed: Mar. 5, 2020
(86) PCT No.: PCT/US2020/021058

§ 371 Date: Aug. 20, 2021

(30) Foreign Application Priority Data
Mar. 5, 2019 (KR) 10-2019-0025358

(51) Int. Cl. B23K 26/402; B23K 26/38; B23K 37/00; B23K 26/14; B23K 26/142; C03B 33/07; C03B 33/09

(52) U.S. Cl. CPC B23K 26/402; B23K 26/38; B23K 37/003; B23K 2103/54; B23K 26/142; C03B 33/074; C03B 33/091; B23K 26/1436

(57) ABSTRACT

A method of processing a glass laminate substrate includes carrying a glass laminate substrate including a glass substrate on a metal substrate to a processing location; radiating a laser onto the metal substrate through the glass substrate; and cooling a portion of the glass substrate, through which the laser is radiated, such that the glass substrate is cut at the portion through which the laser is radiated. When methods of processing and cutting a glass laminate substrate and an apparatus for processing a glass laminate substrate, according to embodiments, are used, a glass laminate substrate having high edge strength after cutting may be produced.

### CROSS-REFERENCE TO RELATED APPLICATION

This application claims the benefit of priority under 35 U.S.C. § 119 to Korean Patent Application No. 10-2019-0025358, filed on Mar. 5, 2019, in the Korean Intellectual Property Office, the disclosure of each of which is incorporated herein in their entirety by reference.

### BACKGROUND

### 1. Field

One or more embodiments relate to an apparatus for processing a glass laminate substrate and processing and cutting methods using the same, and more particularly, to an apparatus for processing a glass laminate substrate having high edge strength even after being cut and processing and cutting methods using the same.

### 2. Description of Related Art

Glass laminate substrates are highly expected to be widely used in various fields of technology in the future, but there is still plenty of room for development in technology for processing a glass laminate substrate.

### SUMMARY

One or more embodiments include a method of processing a glass laminate substrate having high edge strength even after being cut.

One or more embodiments include a method of cutting a glass laminate substrate having high edge strength even after being cut.

One or more embodiments include an apparatus for processing a glass laminate substrate having high edge strength even after being cut.

Additional aspects will be set forth in part in the description which follows and, in part, will be apparent from the description, or may be learned by practice of the presented embodiments of the disclosure.

According to one or more embodiments, a method of processing a glass laminate substrate includes carrying a glass laminate substrate including a glass substrate on a metal substrate to a processing location; radiating a laser onto the metal substrate through the glass substrate; and cooling a portion of the glass substrate, through which the laser is radiated, such that the glass substrate is cut at the portion through which the laser is radiated.

A wavelength of the laser may be about 0.8 μm to about 1.1 μm. The laser may be a fiber laser or an Nd:YAG laser. A power of the laser may be about 3 kW to about 7 kW.

The method may further include moving a location onto which the laser is radiated from one location to another location on the glass laminate substrate. At this time, a moving speed of the location onto which the laser is radiated is about 1 m/min to about 20 m/min.

The cooling may include jetting a cooling gas onto the glass substrate. The cooling gas may include a cooling gas shroud that surrounds the laser. A jetting pressure of the cooling gas may be about 2 atm to about 15 atm. The radiating of the laser may include melting the metal substrate, and the cooling may include blowing melted metal with the cooling gas to remove the melted metal.

A transmittance of the laser with respect to the glass substrate may be equal to or greater than about 85%, and the glass substrate may not be melted by the laser. The glass substrate may be cut by tensile stress applied to the glass substrate during the cooling.

According to one or more embodiments, a method of cutting a glass laminate substrate includes carrying a glass laminate substrate including a glass substrate on a metal substrate to a processing location, locally heating the metal substrate at a cutting location, cooling the glass substrate at the cutting location, and removing a melted portion of the metal substrate at the cutting location.

While the glass substrate is being cooled, the metal substrate may be continuously heated, and the cooling of the glass substrate may include jetting a cooling gas to the cutting location in order to cool the glass substrate. The removing of the metal substrate may include inertially removing the melted portion of the metal substrate at the cutting location by using a mechanical force exerted by the jetting of the cooling gas.

The heating of the metal substrate at the cutting location and the cooling of the glass substrate at the cutting location may be performed substantially simultaneously.

According to one or more embodiments, an apparatus for processing a glass laminate substrate may include a support configured to support a glass laminate substrate including a glass substrate on a metal substrate, a cutter module disposed on the support and configured to radiate a laser onto the glass laminate substrate and to jet a cooling gas onto the glass laminate substrate in order to cut the glass laminate substrate, and a positioner configured to adjust relative positions of the support and the cutter module. At this time, the cutter module may include a laser emitter configured to radiate a laser onto a to-be-cut location on the metal substrate through the glass substrate and a cooling gas nozzle configured to jet the cooling gas to a vicinity of the to-be-cut location.

While the glass laminate substrate is being cut, a focal spot of the laser and an aperture of the cooling gas nozzle are configured to maintain relative positions with regard to each other.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic conceptual diagram of an apparatus for processing a glass laminate substrate, according to an embodiment;

FIG. 2 is an enlarged cross-sectional view of a region II in FIG. 1;

FIG. 3 is a perspective view typically showing the principle of cutting a glass laminate substrate using an apparatus for processing a glass laminate substrate, according to an embodiment;

FIG. 4 is a perspective view typically showing the principle of cutting a glass laminate substrate using an apparatus for processing a glass laminate substrate, according to one or more embodiments;

FIG. 5 is a flowchart of a method of processing a glass laminate substrate, according to an embodiment;

FIG. 6 is an image of a glass laminate substrate, viewed from vertically above, which is not ground after being cut;

FIG. 7 is a graph for comparison in edge strength of a cut surface of a glass laminate substrate before and after grinding after the glass laminate substrate is cut; and

FIG. 8 is a graph showing a change in edge strength of a glass laminate substrate with respect to a grinding amount by which the cut surface of the glass laminate substrate is ground.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

While such terms “first,” “second,” etc., may be used to describe various components, such components must not be limited to the above terms. The above terms are used only to distinguish one component from another. For example, a first element could be termed a second element, and, similarly, a second element could be termed a first element without departing from the teachings of the disclosure.

The terminology used herein is for the purpose of describing particular embodiments only and is not intended to be limiting of the present disclosure. The singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, integers, steps, operations, elements, components, and/or combinations thereof, but do not preclude the presence or addition of one or more other features, regions, integers, steps, operations, elements, components, and/or combinations thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

When it is possible to modify an embodiment, the order of processes may be different from the order in which the processes have been described. For instance, two processes described as being performed sequentially may be substantially performed simultaneously or in a reverse order.

In the drawings, transformation of the shapes may be expected according to, for example, manufacturing techniques and/or tolerance. Accordingly, embodiments should not be construed as being limited to specified shapes in the drawings but as including changes in the shapes occurring during, for example, manufacturing processes. As used herein, the term “and/or” includes any and all combinations of one or more of the associated listed items. In addition, the term “substrate” used herein may refer to a substrate itself or a stack structure that includes a substrate and a certain layer or film formed on a surface of the substrate. The expression “surface of the substrate” may refer to an exposed surface of the substrate itself or an outer surface of a certain layer or film formed on the substrate.

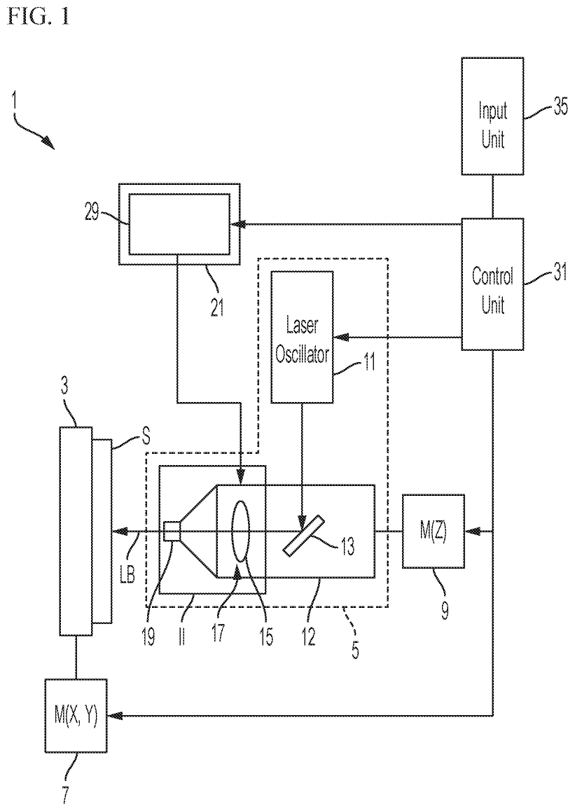

FIG. 1 is a schematic conceptual diagram of an apparatus 1 for processing a glass laminate substrate, according to an embodiment.

Referring to FIG. 1, the apparatus 1 may include a support 3 that supports a glass laminate substrate S and a cutter module 5 that radiates a laser LB to the glass laminate substrate S to cut the glass laminate substrate S. The support 3 is arranged to be relatively movable in X-axis and Y-axis directions with respect to the cutter module 5. A horizontal positioner 7, e.g., a sub-motor, is provided to relatively move the support 3 in the X-axis and Y-axis directions and to determine the position of the support 3. In addition, a vertical positioner 9 is provided to move the cutter module 5 in a direction, e.g., a Z-axis direction, relatively approaching and/or away from the glass laminate substrate S and to determine the position of the cutter module 5.

The apparatus 1 includes a laser emitter 11, which emits the laser LB having a certain range of wavelengths, and more particularly, the laser LB having low absorptivity into glass or high transmittance through glass. The cutter module 5 includes an optical unit 17 including a reflection mirror 13, which reflects the laser LB emitted by the laser emitter 11 toward the glass laminate substrate S, and a focusing lens 15, which focuses the laser LB. The cutter module 5 also includes a cooling gas nozzle 12, which jets a cooling gas to a to-be-cut location on the glass laminate substrate S.

The laser LB emitted by the laser emitter 11 may have a wavelength transmittable through glass. In some embodiments, the laser LB may have a wavelength of about 500 nm to about 2500 nm, a wavelength of about 600 nm to about 2000 nm, a wavelength of about 700 nm to about 1500 nm, or a wavelength of about 800 nm to about 1100 nm. For example, the laser LB may be a Nd:YAG laser or a diode fiber laser. However, embodiments are not limited thereto.

The cutter module 5 may include a side nozzle, which jets a cooling gas toward a processing portion of the glass laminate substrate S, as a configuration for jetting a cooling gas to the to-be-cut location. The apparatus 1 further includes a cooling gas supply unit 21. The cooling gas supply unit 21 may include a pressure control valve 29, which controls a pressure of a cooling gas to be supplied to the cutter module 5.

Examples of the cooling gas may include nitrogen, oxygen, helium, argon, neon, and a mixture thereof.

The apparatus 1 includes a control unit 31. The control unit 31 may control the relative motion and position of the cutter module 5 with respect to the glass laminate substrate S, control the laser output of the laser emitter 11, and control the supply pressure of a cooling gas to the cutter module 5. The control unit 31 may receive various processing conditions through an input unit 35 connected to the control unit 31.

Due to the configuration described above, the glass laminate substrate S is put and positioned on the support 3, and thereafter, the cutter module 5 relatively moves in the X-axis, Y-axis, and Z-axis directions with respect to the glass laminate substrate S such that the glass laminate substrate S is arranged at a determined position. The laser LB emitted by the laser emitter 11 is focused by the focusing lens 15 to be radiated onto the glass laminate substrate S. A cooling gas supplied from the cooling gas supply unit 21 to the cutter module 5 is jetted from the cooling gas nozzle 12 to a processing portion of the glass laminate substrate S, and accordingly, the glass laminate substrate S is laser-cut and processed.

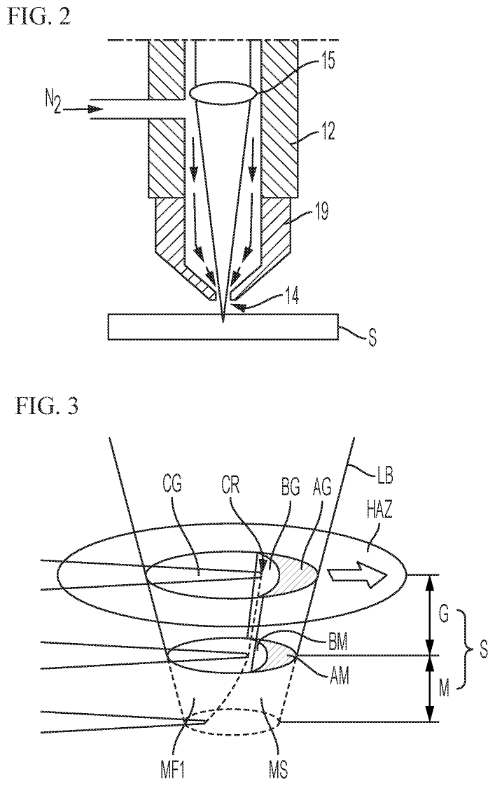

FIG. 2 is an enlarged cross-sectional view of a region II in FIG. 1.

Referring to FIG. 2, the cooling gas nozzle 12 may include a nozzle tip 19. The nozzle tip 19 may include an aperture 14 through which the laser LB may be emitted. The horizontal diameter of an end portion of the nozzle tip 19 may decrease toward the glass laminate substrate S. The diameter of the aperture 14 is smaller than the inner diameter of the cooling gas nozzle 12 and large enough not to disturb the laser LB.

A cooling gas supply passage 16, through which a cooling gas is supplied from the cooling gas supply unit 21 through the pressure control valve 29, may be provided at a side of the cooling gas nozzle 12. The cooling gas supply passage 16 may communicate with an inner space of the cooling gas nozzle 12. A cooling gas supplied through the cooling gas supply passage 16 may flow in a direction shown by the arrows in the inner space and may be discharged through the aperture 14.

In some embodiments, while the glass laminate substrate S is being cut, the relative position between the focal spot of the laser LB and the aperture 14 of the cooling gas nozzle 12 may be maintained constant. When the relative position between the focal spot of the laser LB and the aperture 14 of the cooling gas nozzle 12 is changed while the glass laminate substrate S is being cut, the characteristics of a cut surface may also be changed, and accordingly, it may be difficult to obtain the cut surface having regular strength. However, the relative position between the focal spot of the laser LB and the aperture 14 of the cooling gas nozzle 12 may be changed before the glass laminate substrate S is cut.

FIG. 3 is a perspective view typically showing the principle of cutting the glass laminate substrate S using the apparatus 1, according to an embodiment.

Referring to FIG. 3, the glass laminate substrate S may include a metal substrate M and a glass substrate G stacked on the metal substrate M.

The metal substrate M may include, for example, iron, steel, aluminum, copper, silver, or the like but is not limited thereto. The glass substrate G may have various kinds of composition. For example, the glass substrate G may include a strengthened glass sheet. The glass substrate G may include a thermally or chemically strengthened glass sheet.

In some embodiments, the glass substrate G may include a glass sheet which is chemically strengthened using ion exchange. In the ion exchange, a glass sheet may be immersed in a bath with molten salt for a certain time such that ions on or near a surface of the glass sheet are exchanged with larger metal ions of the molten salt and thus be chemically strengthened. In some embodiments, a temperature of the bath with molten salt may be about 430° C., and the immersion time may be about eight hours.

Since the larger metal ions are included in the glass sheet and compressive stress is formed near the surface of the glass sheet, and accordingly, the glass substrate G may be strengthened. At this time, tensile stress corresponding to the compressive stress may be induced in a central portion of the glass substrate G to be balanced with the compressive stress. Although it is not intended to limit the present disclosure to particular theories, the term “ion exchange” herein used may refer to a process of replacing positive ions on or near the surface of a glass sheet with other positive ions having the same valence.

For example, the glass substrate G may include SiO₂, B₂O₃, and Na₂O, and (SiO₂+B₂O₃) about 66 mol % and Na₂O about 9 mol %. In some embodiments, the glass substrate G may include at least about 6 wt % of aluminum oxide. In some embodiments, the glass substrate G may further include at least one kind of alkaline earth oxides. At this time, the glass substrate G may include at least about 5 wt % of alkaline earth oxides. In some embodiments, the glass substrate G may further include at least one of K₂O, MgO, and CaO. In some embodiments, the glass substrate G may include about 6 1mol % to about 75 mol % of SiO₂, about 7 mol % to about 15 mol % of Al₂O₃, 0 mol % to about 12 mol % of B₂O₃, about 9 mol % to about 21 mol % of Na₂O, 0 mol % to about 4 mol % of K₂O, 0 mol % to about 7 mol % of MgO, and 0 mol % to about 3 mol % of CaO.

In some embodiments, the glass substrate G may include about 60 mol % to about 70 mol % of SiO₂, about 6 mol % to about 14 mol % of Al₂O₃, 0 mol % to about 15 mol % of B₂O₃, 0 mol % to about 15 mol % of Li₂O, 0 mol % to about 20 mol % of Na₂O, 0 mol % to about 10 mol % of K₂O, 0 mol % to about 8 mol % of MgO, 0 mol % to about 10 mol % of CaO, 0 mol % to about 5 mol % of ZrO₂, 0 mol % to about 1 mol % of SnO₂, 0 mol % to about 1 mol % of CeO₂, about 50 ppm or less of As₂O₃, and about 50 ppm or less of Sb₂O₃. In some embodiments, about 12 mol % (Li₂O+Na₂O+K₂O) about 12 mol %. In some embodiments, 0 mol %≤(MgO+CaO) about 10 mol %.

In some embodiments, the glass substrate G may include about 63.5 mol % to about 66.5 mol % of SiO₂, about 8 mol % to about 12 mol % of Al₂O₃, 0 mol % to about 3 mol % of B₂O, 0 mol % to about 5 mol % of Li₂O, about 8 mol % to about 18 mol % of Na₂O, 0 mol % to about 5 mol % of K₂O, about 1 mol % to about 7 mol % of MgO, 0 mol % to about 2.5 mol % of CaO, 0 mol % to about 2.5 mol % of ZrO₂, about 0.05 mol % to about 0.25 mol % of SnO₂, about 0.05 mol % to about 0.5 mol % of CeO₂, about 50 ppm or less of As₂O₃, and about 50 ppm or less of Sb₂O₃. In some embodiments, about 14 mol % (Li₂O+Na₂O+K₂O) about 18 mol %. In some embodiments, about 2 mol % (MgO+CaO) about 7 mol %.

In some embodiments, the glass substrate G may include about 58 mol % to about 72 mol % of SiO₂, about 9 mol % to about 17 mol % of Al₂O₃, about 2 mol % to about 12 mol % of B₂O₃, about 8 mol % to about 16 mol % of Na₂O, and 0 mol % to about 4 mol % of K₂O.

In some embodiments, the glass substrate G may include about 61 mol % to about 75 mol % of SiO₂, about 7 mol % to about 15 mol % of Al₂O₃, 0 mol % to about 12 mol % of B₂O₃, about 9 mol % to about 21 mol % of Na₂O, 0 mol % to about 4 mol % of K₂O, 0 mol % to about 7 mol % of MgO, and 0 mol % to about 3 mol % of CaO.

In some embodiments, the glass substrate G may include about 60 mol % to about 70 mol % of SiO₂, about 6 mol % to about 14 mol % of Al₂O₃, 0 mol % to about 15 mol % of B₂O₃, 0 mol % to about 15 mol % of Li₂O, 0 mol % to about 20 mol % of Na₂O, 0 mol % to about 10 mol % of K₂O, 0 mol % to about 8 mol % of MgO, 0 mol % to about 10 mol % of CaO, 0 mol % to about 5 mol % of ZrO₂, 0 mol % to about 1 mol % of SnO₂, 0 mol % to about 1 mol % of CeO₂, about 50 ppm or less of As₂O₃, and about 50 ppm or less of Sb₂O₃; 12 mol %≤Li₂O+Na₂O+K₂O≤20 mol %; and 0 mol % MgO+CaO≤10 mol %.

In some embodiments, the glass substrate G may include about 64 mol % to about 68 mol % of SiO₂, about 12 mol % to about 16 mol % of Na₂O, about 8 mol % to about 12 mol % of Al₂O₃, 0 mol % to about 3 mol % of B₂O₃, about 2 mol % to about 5 mol % of K₂O, about 4 mol % to about 6 mol % of MgO, and 0 mol % to about 5 mol % of CaO; about 66 mol % (SiO₂ B₂O₃+CaO)≤about 69 mol %; (Na₂O−Al₂O₃)≤B₂O₃+MgO+CaO+SrO)>about 10 mol %; about 5 mol %≤(MgO +CaO+SrO)≤about 8 mol %; (Na₂O+B₂O₃)−Al₂O₃≤about 2 mol %; about 2 mol %≤(Na₂O−Al₂O₃)≤about 6 mol %; and about 4 mol % (Na₂O+K₂O)−Al₂O₃≤about 10 mol %.

In the above ranges of numerical values, when a lower limit of the content of a certain component is 0, the component may be included or not.

The metal substrate M may have a thickness of, for example, about 0.1 mm to about 10 mm. The glass substrate G may have a thickness of, for example, about 0.1 mm to about 5 mm.

The laser LB may be radiated onto the glass laminate substrate S including the metal substrate M and the glass substrate G, which are stacked. As described above, the laser LB may have a wavelength satisfactorily transmitting the glass substrate G and may be radiated onto the metal substrate M through the glass substrate G. In some embodiments, a transmittance of the laser LB with respect to the glass substrate G may be equal to or greater than about 85%, about 90%, about 93%, about 95%, about 96%, about 97%, about 98%, or about 99%.

When a laser having a low transmittance with respect to the glass substrate G, e.g., a CO₂ laser, is radiated, light energy of the laser is absorbed by the glass substrate G and then converted into thermal energy, thereby melting glass, and therefore, a cut surface may be irregular and may have low mechanical strength.

As shown in FIG. 3, the laser LB is radiated from above the glass substrate G onto the metal substrate M through the glass substrate G. A region, in which the laser LB intersects with each of a top surface of the glass substrate G and a top surface of the metal substrate M, is illustrated as a circle. As shown in FIG. 3, since a focal spot of the laser LB is positioned inside or below the glass laminate substrate S, the area of the region, in which the laser LB intersects with the top surface of the glass substrate G, may be greater than the area of the region, in which the laser LB intersects with the top surface of the metal substrate M.

Although it is illustrated in FIG. 3 that the laser LB intersects with a bottom surface of the metal substrate M after passing through the metal substrate M, it is just for showing an intended path of the laser LB for convenience's sake and may be different from an actual phenomenon.

The laser LB cuts the glass laminate substrate S while travelling in an arrow direction. The laser LB may be mostly absorbed into the metal substrate M after passing through the glass substrate G and then converted into thermal energy. Accordingly, the temperature of the metal substrate M increases due to the laser LB. The thermal energy in the metal substrate M is transferred to the glass substrate G, and accordingly, the temperature of the glass substrate G also increases.

Due to the incidence of the laser LB, the temperatures of the metal substrate M and the glass substrate G locally increase, and accordingly, a heat-affected zone (HAZ) is formed. A region, in which the HAZ intersects with the top surface of the glass substrate G, is shown in FIG. 3, and the HAZ extends below a circle denoted by “HAZ” in FIG. 3.

Heat is transferred from the metal substrate M to a region at a front end of a horizontal travelling direction (i.e., the arrow direction in FIG. 3) of the laser LB, and accordingly, the glass substrate G starts to heat up. In detail, a region AM at the front end in FIG. 3 refers to a region of the metal substrate M, which has been recently incorporated into a region onto which the laser LB is radiated and which starts to rapidly heat up via the radiation of the laser LB. In addition, the heat in the region AM is transferred to the glass substrate G and also contributes to an increase in a temperature of a region BM.

The region BM in the back of the region AM in the horizontal travelling direction of the laser LB has spent longer time in the region, onto which the laser LB is radiated, than the region AM, and thus has a higher temperature than the region AM. Therefore, the region BM of the metal substrate M undergoes considerable thermal expansion, and accordingly, a region BG of the glass substrate G becomes to have considerable tensile stress, wherein the region BG corresponds to the region BM. In addition, when the glass substrate G is cooled at the region BG and/or a region AG, the tensile stress applied to the glass substrate G further increases. This tensile stress increases in an opposite direction of the horizontal travelling direction of the laser LB (since the temperature of the metal substrate M increases in the opposite direction), and the glass substrate G eventually cracks at a certain point, e.g., a point CR. As described above, the glass substrate G may be cut in the travelling direction of the laser LB.

Meanwhile, as shown in FIG. 3, a portion of the glass substrate G in the back of the point CR has already cracked and been divided, and a portion of the metal substrate M further back from the point CR may be continuously heated by the laser LB. As a result of continuously heating the metal substrate M, the metal substrate M is locally melted, and a melted portion having fluidity in the metal substrate M is removed by a cooling gas jetted at a high pressure. In FIG. 3, a portion MS of the metal substrate M has a high temperature but does not have fluidity. A portion MF1 of the metal substrate M has fluidity to a degree via melting and is removed by jetting a cooling gas.

Referring to FIGS. 2 and 3, the cooling gas may be jetted and form a shroud surrounding the laser LB. The cooling gas may be jetted toward the glass laminate substrate S, overlapping the laser LB.

Overall, the glass substrate G may be divided by the crack described above, and the metal substrate M may be divided by being locally melted and removed by the jetting of a cooling gas. The description made above with reference to FIG. 3 is not intended to be limited by particular theories, and cutting may be performed according to other principles than described above.

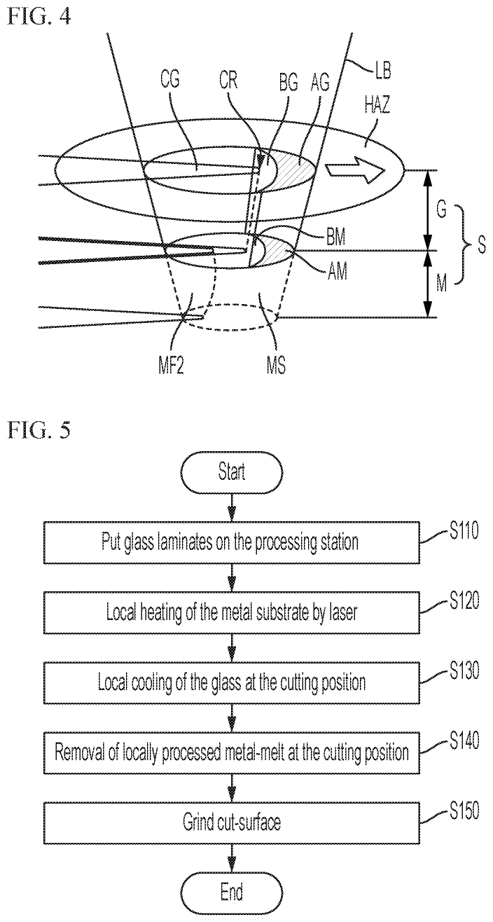

FIG. 4 is a perspective view typically showing the principle of cutting the glass laminate substrate S using the apparatus 1, according to another embodiment. The embodiment illustrated in FIG. 4 is different from that illustrated in FIG. 3 in that the cutting of the metal substrate M is performed further back in the travelling direction of the laser LB. Hereinafter, the embodiment illustrated in FIG. 4 will be described, focusing on this difference.

Referring to FIG. 4, it may take longer for the metal substrate M to be melted and have fluidity than in the embodiment illustrated in FIG. 3. In this case, the laser LB needs to be radiated longer to allow the metal substrate M to have fluidity, and accordingly, a portion having the fluidity may be positioned further back in the travelling direction of the laser LB in the embodiment illustrated in FIG. 4 than in the embodiment illustrated in FIG. 3.

In addition, a front end of a portion MF2 of the metal substrate M may not coincide with a front end, i.e., the point CR, of a crack of the glass substrate G, wherein the portion MF2 is melted and removed.

FIG. 5 is a flowchart of a method of processing the glass laminate substrate S, according to an embodiment.

Referring to FIGS. 1 and 5, the glass laminate substrate S may be carried to a processing location in operation S110. The processing location may be on the support 3 of the apparatus 1 for processing the glass laminate substrate S. In some embodiments, the processing location may correspond to an aiming location at which the laser LB emitted from the cutter module 5 is aimed.

The glass laminate substrate S has been described in detail with reference to FIG. 3 above, and thus detailed descriptions thereof will be omitted.

Referring to FIGS. 3 and 5, the metal substrate M may be locally heated by radiating the laser LB to a cutting location in operation S120. As described above, the laser LB may pass through the glass substrate G. Accordingly, energy of the laser LB may be mostly absorbed into the metal substrate M, and therefore, the metal substrate M may be heated.

The laser LB may have a power of about 3 kW to about 7 kW or of about 4 kW to about 6 kW. When the power of the laser LB is too low, the glass laminate substrate S may not be cut. On the contrary, when the power of the laser LB is too high, the strength of a cut surface may be unsatisfactory.

A focal spot of the laser LB may be set to a position inside or below the glass laminate substrate S.

Thereafter, the glass substrate G may be locally cooled at the cutting location in operation S130. The cooling may be performed by jetting a cooling gas. The cooling gas has been described with reference to FIG. 1 above, and thus detailed descriptions thereof will be omitted. The cooling gas may be jetted at an atmospheric pressure of about 4 atm to about 20 atm, about 6 atm to about 18 atm, or about 8 atm to about 15 atm. When a jetting pressure of the cooling gas is too high or low, the glass laminate substrate S may not be cut.

Since the glass substrate G at the cutting location shrinks due to the cooling gas and the metal substrate M is heated by absorbing the laser LB, which is continuously radiated, tensile stress may be applied to the glass substrate G in the regions BM and BG in FIG. 3. When the temperature of the metal substrate M at the cutting location increases, the tensile stress applied to the glass substrate G also increases. When the tensile stress exceeds a limit endurable by the glass substrate G, the glass substrate G cracks and is divided at the point CR in FIG. 3.

Thereafter, in operation S140, the metal substrate M may be locally melted, and a melted portion of the metal substrate M may be blown and removed using the cooling gas at the cutting location, so that the metal substrate M may be divided.

Although a power of the laser LB is about 3 kW to about 7 kW, the cross-section of the laser LB is very small, and therefore, the laser LB at a location to which the laser LB is radiated has a very high energy density of several MW/cm² to several tens of MW/cm². Accordingly, as described above with reference to FIG. 3, the metal substrate M may be locally melted at the location to which the laser LB is radiated.

The metal substrate M that has been locally melted has fluidity and may thus be inertially removed by the mechanical force of the cooling gas jetted at a high pressure.

At this time, the glass substrate G transmits the laser LB and is thus not melted by the laser LB. However, since the temperature of the metal substrate M becomes high, the glass substrate G may be locally and momentarily melted by heat transferred from the metal substrate M.

The operations described above, i.e., operation S120 of locally heating the metal substrate M by radiating the laser LB, operation S130 of locally cooling the glass substrate G at the cutting location, and operation S140 of dividing the metal substrate M by locally melting the metal substrate M at the cutting location and removing the melted portion of the metal substrate M by blowing the melted portion with the cooling gas at the cutting location, are subsequently performed so as to eventually cut the glass laminate substrate S. However, this series of operations are continuously performed in a very small area, i.e., the cutting location on which the laser LB is focused, and may thus be considered as being performed substantially simultaneously.

A radiation location to which the laser LB is radiated, i.e., the cutting location, may be continuously moved on the glass laminate substrate S in the travelling direction of the laser LB, i.e., the arrow direction in FIG. 3. When the cutting location is continuously moved and the operations described above are sequentially performed in the cutting location, the glass laminate substrate S may be cut into a desired shape and size.

A moving speed of the cutting location may be about 1 m/min to about 10 m/min, about 1.5 m/min to about 9 m/min, about 2 m/min to about 8 m/min, or about 2.5 m/min to about 7 m/min. When the moving speed of the cutting location is too slow, productivity may be unsatisfactory, resulting in economic disadvantages. When the moving speed of the cutting location is too fast, the glass laminate substrate S may not be cut or mechanical strength at the cutting location may be insufficient.

Thereafter, a certain portion of the glass laminate substrate S may be removed by grinding a cut surface thereof in operation S150. FIG. 6 is an image of the glass laminate substrate S, viewed from vertically above, which is not ground after being cut. Referring to FIG. 6, there is a HAZ A having a width of about 650 μm to about 700 μm from an edge of the glass substrate G. The HAZ A is an area of the metal substrate M (located below the glass substrate G in the sight direction in FIG. 6), wherein the area has been influenced by thermal expansion or melting during cutting and then cooled.

A glass fracture area B, in which glass is fractured and divided, may extend, with a width of about 280 μm to about 320 μm, along an edge of the HAZ A; and a flaw area C, which is combusted by a high-temperature laser and is structurally brittle, may extend, with a width of about 80 μm, along the edge of the HAZ A. However, the numerical values of the width of each area may depend on and vary with particular test conditions.

Referring to FIG. 6, a portion of a cut surface within the glass fracture area B may be removed via grinding, and particularly, the cut surface may be ground such that at least the flaw area C is removed.

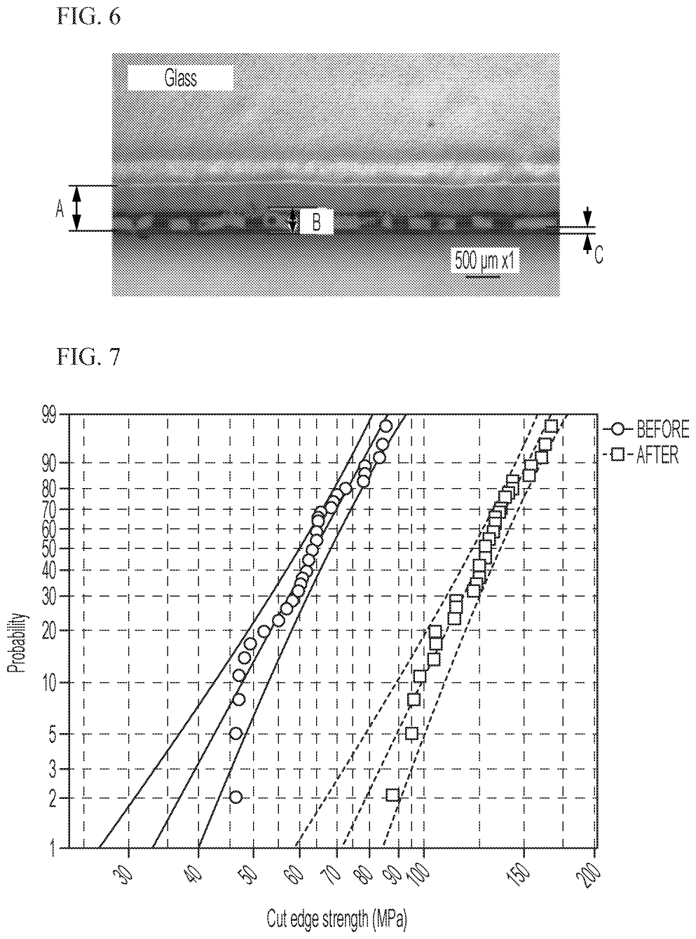

FIG. 7 is a graph for comparison in edge strength of a cut surface of the glass laminate substrate S before and after grinding after the glass laminate substrate S is cut.

Referring to FIG. 7, it is seen that the edge strength is significantly increased after the grinding as compared to the edge strength before the grinding. A strength test was performed using a 4-point probe (4PB).

Although the present disclosure is not intended to be limited by particular theories, it is inferred that the HAZ A causes a metal substrate to be expanded and shrunk, resulting in densification of the structure of a portion of a glass substrate, which is present on the metal substrate, so that the strength is enhanced. In particular, it is interpreted as that when a portion (e.g., the flaw area C in FIG. 6), which has a weak structure at an edge before the grinding right after the cutting, is not removed via the grinding, a crack initiated from the portion propagates and inhibits the appropriate exhibition of the enhanced strength of the HAZ A, but when the portion (i.e., the flaw area C in FIG. 6) is removed via the grinding, the enhanced strength of the HAZ A may be appropriately exhibited.

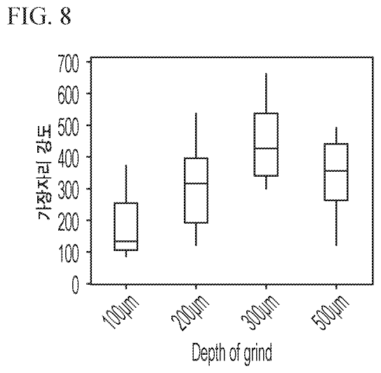

FIG. 8 is a graph showing a change in edge strength of the glass laminate substrate S with respect to a grinding amount by which the cut surface of the glass laminate substrate S is ground.

Referring to FIG. 8, 4PB strength increases up to a grinding amount of 300 μm, which is interpreted as that mechanical strength is increased by removing a weak portion as described above. When the cut surface is ground to a depth of 500 μm, the 4PB strength decreases, which is interpreted as that mechanical strength is decreased since a HAZ having high strength is significantly removed.

Although there are various methods of cutting a substrate, when these methods are applied to a glass laminate substrate, edge strength is less than 100 MPa, which is not sufficient for industrial application. For example, the edge strength is about 47 MPa when a CO₂ laser is used, about 54 MPa when a dicing saw is used, about 78 MPa when a sandblast is used, about 47 MPa when a water jet is used, about 78 MPa when a computer numerical control (CNC) machine is used, and about 53 MPa when a diamond wheel is used. However, when a glass laminate substrate is cut using a method according to an embodiment, high edge strength that is much higher than 150 MPa may be obtained.

When methods of processing and cutting a glass laminate substrate and an apparatus for processing a glass laminate substrate, according to embodiments, are used, a glass laminate substrate having high edge strength after cutting may be produced.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A method of processing a glass laminate substrate, the method comprising:
carrying a glass laminate substrate including a glass substrate on a metal substrate to a processing location;
radiating a laser onto the metal substrate through the glass substrate; and
cooling a portion of the glass substrate through which the laser is radiated, such that the glass substrate is cut at a portion through which the laser is radiated.

2. The method of claim 1, wherein a wavelength of the laser is about 0.8 μm to about 1.1 μm.

3. The method of claim 1, wherein the laser is a fiber laser or an Nd:YGA laser.

4. The method of claim 1, wherein a power of the laser is about 3 kW to about 7 kW.

5. The method of claim 1, further comprising moving a location onto which the laser is radiated from one location to another location on the glass laminate substrate.

6. The method of claim 5, wherein, in the moving of the location onto which the laser is radiated, a moving speed of the location onto which the laser is radiated is about 1 m/min to about 20 m/min.

7. The method of claim 1, wherein the cooling comprises jetting a cooling gas onto the glass substrate.

8. The method of claim 7, wherein the cooling gas comprises a cooling gas shroud that surrounds the laser.

9. The method of claim 7, wherein a jetting pressure of the cooling gas is about 2 atm to about 15 atm.

10. The method of claim 9, wherein
the radiating of the laser comprises melting the metal substrate, and
the cooling comprises blowing melted metal with the cooling gas to remove the melted metal.

11. The method of claim 1, wherein a transmittance of the laser with respect to the glass substrate is equal to or greater than about 85%.

12. The method of claim 11, wherein the glass substrate is not melted by the laser.

13. The method of claim 11, wherein the glass substrate is cut by tensile stress applied to the glass substrate during the cooling.

14. A method of cutting a glass laminate substrate, the method comprising:
carrying a glass laminate substrate including a glass substrate on a metal substrate to a processing location;
locally heating the metal substrate at a cutting location;
cooling the glass substrate at the cutting location; and
removing a melted portion of the metal substrate at the cutting location.

15. The method of claim 14, wherein, while the glass substrate is being cooled, the metal substrate is continuously heated.

16. The method of claim 15, wherein the cooling of the glass substrate comprises jetting a cooling gas to the cutting location in order to cool the glass substrate.

17. The method of claim 16, wherein the removing of the metal substrate comprises removing the melted portion of the metal substrate at the cutting location by using a mechanical force exerted by the jetting of the cooling gas.

18. The method of claim 14, wherein the heating of the metal substrate at the cutting location and the cooling of the glass substrate at the cutting location are performed substantially simultaneously.

19. An apparatus for processing a glass laminate substrate, the apparatus comprising:
a support configured to support a glass laminate substrate including a glass substrate on a metal substrate;
a cutter module disposed on the support and configured to radiate a laser onto the glass laminate substrate and jet a cooling gas onto the glass laminate substrate in order to cut the glass laminate substrate; and
a positioner configured to adjust relative positions of the support and the cutter module,
wherein the cutter module comprises:
a laser emitter configured to radiate a laser onto a to-be-cut location on the metal substrate through the glass substrate; and
a cooling gas nozzle configured to jet the cooling gas to a vicinity of the to-be-cut location.

20. The apparatus of claim 19, wherein, while the glass laminate substrate is being cut, the laser emitter and the cooling gas nozzle are configured to maintain the relative position with regard to each other.
